(19) United States
(12) Patent Application Publication
(10) Pub. No.: US 2015/0309774 A1
(43) Pub. Date: Oct. 29, 2015

(54) METHOD AND DEVICE FOR CHANGING OBJECTS IN A HUMAN-MACHINE INTERFACE DEVICE

(71) Applicant: OMRON CORPORATION, Kyoto-shi, Kyoto (JP)

(72) Inventors: Steven Gary LODWIDGE, Southampton (GB); Fumio KAWAKAMI, Kyoto (JP); Hiromi ISHIHARA, Moriyama (JP); Christopher Ian MORRIS, Fareham (GB); Timothy Paul BICKERSTAFF, Southampton (GB)

(73) Assignee: OMRON Corporation, Kyoto-shi, KYOTO (JP)

(21) Appl. No.: 14/647,171

(22) PCT Filed: Nov. 25, 2013
(86) PCT No.: PCT/GB2013/053107

§ 371 Date: May 26, 2015

(30) Foreign Application Priority Data
Nov. 27, 2012 (GB) 1221317.9

(51) Int. Cl. G06F 9/44; G05B 19/05

(52) U.S. Cl. CPC G06F 8/38; G05B 19/05; G05B 2219/13144

(57) ABSTRACT

When a programmer creates an object for use in a display screen of a human-machine interface device of a programmable system, at least some of the properties of the object are associated with a variable quantity. The programmer determines the property or properties for which the corresponding variable quantity is reassignable and which are fixed, by carrying out a setting operation, and creating an association record identifying which property or properties have a reassignable variable quantity. The object may then be stored in a library and transferred to the memory of the human-machine interface device. If a subsequent programmer wants to re-use the object by reassigning the variable quantity of one or more of the properties of the object, the association record is used to determine the property or properties for which the corresponding variable quantity is reassignable.

### BACKGROUND OF THE INVENTION

1. Field of the Invention

The present invention relates to a method of changing objects for use in a screen of a human-machine interface device of a programmable system. It also relates to a programmable computer device for changing an object for use in a display system of a human-machine interface device for a programmable system, and to a computer program, possibly one recorded on a recording medium, for running on a programmable computer device for changing an object for use in a display screen of a human-machine interface device of a programmable system.

2. Summary of the Prior Art

It is common for a programmable system, such as one involving one or more programmable logic controllers which control other elements of the system, itself to be controlled via a human-machine interface device (hereinafter referred to as an ‘HMI device’, and the term HMI will be used generally for any human-machine interface), which allows a user to interact with the programmable system e.g. by touching a touch screen of the human-machine interface device, or by otherwise acting on that screen to trigger responses. In order for such interactions to occur, the screen of the HMI device must be programmed to show appropriate images.

Such screen images are created from one or more image structures, which are generally known as “objects”. Each object may contain display parts, parts by which the user can interact with the object, such as press buttons and the like, and textual information to guide the user. Whilst the screen of the HMI device may display only one such object, it is common for the screen image to contain multiple objects, arranged in a way which enables the user best to interact with the HMI device, and hence the programmable system. Indeed, it is often the case that the HMI device will contain multiple screen images, with different objects in them, to allow different users to interact in different ways with the HMI device. For example, the screen image which is presented to someone whose sole job is to operate the programmable system may be different from the screen needed by someone who has the job of maintenance or repair of the programmable system, and an administrator of the program system may have yet another screen.

Thus, in practice, objects for use in the screen images may be stored in a library, or a series of screen structures for generating images, each containing one or more objects, may be stored in that library. The term ‘screen structure’ is used here to indicate an assembly of one or more objects, and possibly other items such as text or images, in a data structure which, when displayed on the screen of e.g. an HMI device, will cause the assembly to be displayed in a way determined by the person who created the screen structure.

In principle, the creation of an object for use in such a HMI device requires complex programming. Whilst there may be programming tools involving program elements to create the objects, the objects have to be put together in an appropriate arrangement, the various operations linked, and the appropriate scripts, etc. written in order successfully to create the object. Thus, the creation of a library of objects or screen structures incorporating such objects for an HMI device may involve considerable effort and skill.

Moreover, in the operation of a programmable system, it is often the case that new objects and or new screen structures have to be created, when the functions carried out by the programmable system are expanded or otherwise changed. In principle, when that happens, a skilled programmer needs to create a new object, or a new screen structure incorporating a new object or objects. The burden of revision of the programmable system is thus increased.

U.S. Pat. No. 7,324,856 disclosed an arrangement which sought to simplify such creation of new objects, by proposing that existing objects were modified to create new objects. The use of such existing objects to create new objects will hereinafter be referred to as “re-use” of objects. In U.S. Pat. No. 7,324,856, it was proposed that a HMI analyser was able to analyse existing objects, to generate a HMI code which could then be edited for subsequent use. Nevertheless, the programmer re-using the object has still to be able to understand and use HMI code that was generated.

U.S. Pat. No. 7,324,856 also mentioned that the HMI object editor could present a template with modifiable fields that define parameters of an object. The aim of such a template was to facilitate object editing by a less skilled programmer. However, no details of such arrangements were discussed in U.S. Pat. No. 7,324,856.

### SUMMARY OF THE INVENTION

At its most general, the present invention proposes that whether or not a property or properties of an object for use in a screen of a human machine interface device is to have the corresponding variable quantity is re-assignable (i.e. can be changed by a subsequent programmer) is determined by a setting operation carried out by the programmer who initially creates that property or properties of the object. Information is stored which identifies those properties for which the corresponding variable quantity is re-assignable. Then, when the object is retrieved by a subsequent programmer, a record of which properties are re-assignable is also retrieved, and that information used to display to the subsequent programmer which properties have their corresponding variable quantity re-assignable.

Thus, when the object is created, the creator programmer determines which properties of the object may be changed (reassigned) and the information about this is then displayed to a subsequent programmer who retrieves the object. Thus, the subsequent programmer knows which properties of the object are re-assignable, and which are not, due to the setting operation carried out by the creator programmer.

Thus, according to a first aspect, the present invention may provide a method of changing an object for use in a display screen of a human-machine interface device of a programmable system, comprising the steps of:
creating said object, said object comprising an assembly of properties of said object, at least some of said properties being properties associated with a corresponding variable quantity;
determining for said properties of said object associated with a corresponding variable quantity a property or properties for which the corresponding variable quantity is re-assignable, with other property or properties of the object associated with a corresponding variable quantity being fixed;
storing said object in a library;
retrieving said object from said library;
displaying said property or properties of said object for which the corresponding variable quantity is re-assignable;
reassigning a different variable quantity to a property of said property or properties for which the corresponding variable quantity is re-assignable, thereby to change said object and thus create a new object; and
transferring said new object to a memory of said human-machine interface device, for display on said display screen;
wherein:
said determining step includes carrying out a setting operation to determine said property or properties for which the corresponding variable quantity is re-assignable and creating an association record identifying said property or properties for which the corresponding variable quantity is re-assignable;
said storing step includes storing said association record in said library; and
said retrieving step includes retrieving said association record;
wherein said association record is used in said displaying step to identify for display said property or properties for which the corresponding variable quantity is re-assignable.

In one alternative, the setting operation involves presenting a list of candidate ones of the properties of the object, and setting amongst those candidate ones of properties, the property or properties for which the corresponding variable quantity is re-assignable. In this arrangement, the program which the creator programmer uses to determine which property or properties may be changed and which cannot is based on a candidate list.

In such a case, the list of candidate ones of said properties of said object for which the corresponding variable quantity is settable to be re-assignable may be displayed together with check boxes associated with said candidate ones of said properties, the checking of one of said check boxes identifying the corresponding one of the candidate ones of said properties which are re-assignable, thereby to set the property or properties for which the corresponding variable quantity is re-assignable.

However, there are other possible setting operations to determine which property or a properties of the object has the corresponding variable quantity re-assignable. For example, and depending on the programming language used, the setting operation may comprise setting the variable quantity as a global variable. A global variable is one that is accessible in every scope (unless shadowed). The scope here is the context within the program in which the variable is valid and can be used. Variable shadowing occurs when a variable declared within a certain scope has a same name in a variable declared in a broad scope.

In such an arrangement, the fact that the variable quantity is a global variable enables a subsequent programmer to vary it. Quantities which are not set as global variables cannot be varied by a subsequent programmer.

In such arrangements, based on candidate's lists, global variables, or in other ways, it is convenient for the subsequent programmer if the property or properties for which the corresponding variable quantity is re-assignable are displayed in a template. The template will be derived using the association record that was created when the object was created.

Preferably, when the creator programmer determines which property or properties have variable quantities which can be reassigned, the creator programmer may set representative names for the corresponding variable quantities.

Once a new object has been created, by reassigning the variable quantity associated with the property or a property of the object, the object may be transferred to the memory of the human-machine interface device as part of a screen structure. Indeed, it is usual for objects to be stored as part of the screen structure in the library. Then, an initial screen structure is stored in the library when said object is stored in said library, the initial screen structure containing said object is retrieved from the library when at least one object is retrieved from said library, and prior to the transferring, the new object replaces the object in said initial screen structure, thereby to form the screen structure which is transferred.

Preferably, of the new object to the human-machine interface device, prior to transferring to the human-machine interface device, the screen structure incorporating the new object may be stored in the library.

It may be noted that a screen structure may involve a plurality of objects, each comprising an assembly of properties of the corresponding objects.

In a second aspect, the present invention may provide a programmable computer device for changing an object for use in a display screen of a human-machine interface device of a programmable system, the computer device having a processor and a memory, the processor being arranged to:
create said object, said object comprising an assembly of properties of said object, at least some of said properties being properties associated with a corresponding variable quantity;
determine for said properties of said object associated with a corresponding variable quantity a property or properties for which the corresponding variable quantity is re-assignable, with other property or properties of the object associated with a corresponding variable quantity being fixed, by carrying out a setting operation to determine said property or properties for which the corresponding variable quantity is re-assignable and creating an association record identifying said property or properties for which the corresponding variable quantity is re-assignable;
store said object and said association record in a library in said memory of said computer device;
retrieve said object and said association record from said library;
display said property or properties of said object for which the corresponding variable quantity is re-assignable;
reassign a different variable quantity to a property of said property or properties for which the corresponding variable quantity is re-assignable, thereby to change said object and thus create a new object; and
transfer said new object to a memory of said human-machine interface device, for display on said display screen;
wherein said association record is used by said processor to identify for display said property or properties for which the corresponding variable quantity is re-assignable.

In a third aspect, the present invention may provide a computer program which, when run on a programmable computer device for changing an object for use in a display screen of a human-machine interface of a programmable system, causes the computer device to carry out the steps of:
creating said object, said object comprising an assembly of properties of said object, at least some of said properties being properties associated with a corresponding variable quantity;
determining for said properties of said object associated with a corresponding variable quantity a property or properties for which the corresponding variable quantity is re-assignable, with other property or properties of the object associated with a corresponding variable quantity being fixed;
storing said object in a library;
retrieving said object from said library;
displaying said property or properties of said object for which the corresponding variable quantity is re-assignable;
reassigning a different variable quantity to a property of said property or properties for which the corresponding variable quantity is re-assignable, thereby to change said object and thus create a new object; and
transferring said new object to a memory of said human-machine interface device, for display on said display screen;
wherein:
said determining step includes carrying out a setting operation to determine said property or properties for which the corresponding variable quantity is re-assignable and creating an association record identifying said property or properties for which the corresponding variable quantity is re-assignable;
said storing step includes storing said association record in said library; and
said retrieving step includes retrieving said association record;
wherein said association record is used in said displaying step to identify for display said property or properties for which the corresponding variable quantity is re-assignable.

That program may be recorded on a recording medium.

### BRIEF DESCRIPTION OF THE DRAWINGS

Embodiments of the invention will now be described in detail, by way of example, with reference to the accompanying drawings, in which:

FIG. 1 shows an example of an object which may be used as part of a screen structure in a HMI display;

FIGS. 2a and 2b show displays which may be used in the present invention to display different properties of the object of FIG. 1, to indicate which are changeable;

FIGS. 3 and 4 show two operations carried out by the object of FIG. 1;

FIG. 5 shows schematically a programmable system involving a HMI device;

FIG. 6 shows in more detail the computer and HMI device of the system of FIG. 5;

FIG. 7 shows operations carried out when an object is created; and

FIG. 8 shows operations carried out when an object is re-used.

### DETAILED DESCRIPTION

As previously discussed, where a programmable system is to be controlled by a HMI device, the HMI device will have a screen via which the user interacts with the device. The image on that screen (which is formed from a “screen structure”) is made up of one or more objects, i.e. image components which together define a part of the screen image with which the user interacts, and possibly other image elements such as text and/or images.

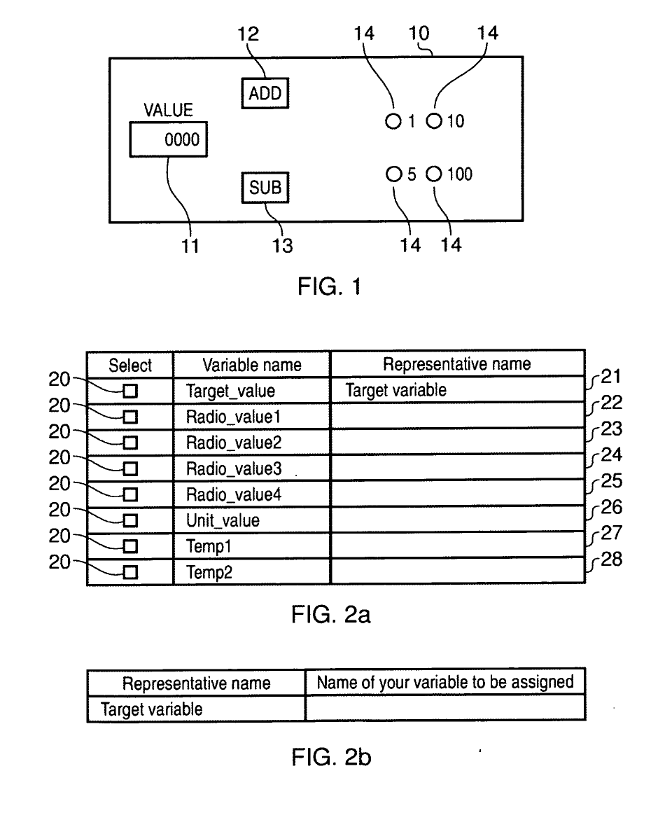

FIG. 1 shows an example of an object. It is a simple one, which is to allow a user to increase or decrease the value of a quantity of a parameter of a system controlled by the HMI device on which the object is displayed. The object 10 comprises a value display part 11 for displaying a value to be changed by a user interacting with the object 10, addition and subtraction buttons 12, 13 and radio buttons 14 which are associated with numerical values “1”, “5”, “10” and “100” by which the value can be changed.

Thus, if the radio button 14, responding to quantity “5” is selected by the user, and the addition button 12 pressed, the value shown in the display part will be incremented by “5”, and this change will trigger a corresponding change in the programmable device controlled by the HMI device so that the quantity represented by the value shown in the display part 11 is also incremented by “5”. Others of the radio buttons 14 can be selected to change the value at a different rate, and the value can be decreased by the quantity indicated by the selected radio button 14 by use of the subtraction button 13. The object 10 shown in FIG. 1 is thus a simple way for the user to control the quantity represented by the value shown in the display part 11.

However, the creation of even such an apparently simple object is not straight forward. Even if the programming tools for the HMI device include program elements to create the display part 11, the addition and subtraction buttons 12, 13 and the radio buttons 14, it is necessary for the programmer creating the object to assemble them appropriately, and to associate the various parts of the object 10, so that they perform their desired function when the object is operated by the user. In practice, the relationships needed for such assembly and association need to be determined by the programmer using a suitable scripting program, or other arrangements for creating objects for use in a HMI device, and this process requires a considerable level of programming skill. If a new object is needed, and has to be created from scratch, an inexperienced programmer cannot carry out the work needed.

Moreover, in practice, objects such as the object 10 shown in FIG. 1 are assembled into screen structures, normally involving multiple objects and other image elements such as text or images, which again need significant programming skill. Indeed, an HMI device for a programmable system may need multiple screen structures, to control different parts of the system, or to allow different types of users to perform different operations on the system, and the assembly of multiple objects into multiple screen structures is again complicated.

If the programmable system is to have a new function, or it to permit one or more types of user to interact with it in different ways, two or more screen structures may need to be created. However, in some cases, the changes needed are relatively small. Therefore, it is desirable some times to use one or more existing objects, and indeed existing screen structures, but to re-use those objects or screen structures for a different purpose. The re-use effectively creates a new object and/or screen structure.

For example, there may be a wish to change object 10, so that it enables change of the programmable system so that the value shown in display part 11 is changed to change the quantity represented from one parameter to another. For example, if the object 10 is initially set-up so that the value shown in display part 11 corresponds to a temperature in some part of the programmable system, it may be desirable to use the same object 10 to control e.g. a pressure at another part of the programmable system. Thus, it is desirable to be able to change the parameter corresponding to the value shown in display part 11 from one parameter to another.

However, with existing systems, either this change has to be done by an experienced programmer, or there is a risk that an inexperienced programmer will accidentally alter some other part of the object 10. As mentioned before, the programming involved in the creation of the object 10 is complicated.

In this embodiment of the present invention, objects such as object 10 have, when they are created, a table or other list of the properties of the object for which the corresponding properties are capable of being re-assigned. Of course, there may be some properties which are incapable of being re-assigned, and such properties need not be indicated at this stage.

However, the intention is that the programmer who creates the object is presented with candidate properties for re-assignment. The creator programmer thus can select from those candidate properties those which a subsequent programmer is allowed to re-assign and which may not be re-assigned (and so are fixed by the creator programmer). That selection thus determines the ways in which the object may be re-used. Thus, when the object 10 is created, the creator determines how a subsequent programmer may re-use that object. For example, to take the object 10 shown in FIG. 1, the creator may set the object so that the quantity represented by the value shown in display part 11 can be freely changed, but all other elements of the object cannot.

Then, if another programmer wishes to re-use the object 10, he will be presented with information which showed how the object can be re-used, and the limitations on the modifications possible. For example, the programmer wishing to re-use the object may be presented with a template which shows the property or properties that may be re-assigned. It may also show properties which cannot be re-assigned, but this is not essential.

When the programmer wishing to re-use the object 10 retrieves that object, either individually from a program library or as part of a screen structure, the template will be shown at the same time. The template indicates to the programmer seeking to re-use the object 10 which properties of the object are re-assignable (i.e. which can be changed). Other properties of the object may also be displayed, but the programmer will know that they cannot be changed.

FIG. 2(a) shows a display which a programmer creating the object 10 may use to select the property or properties of the object which may be re-assigned when the object 10 is re-used.

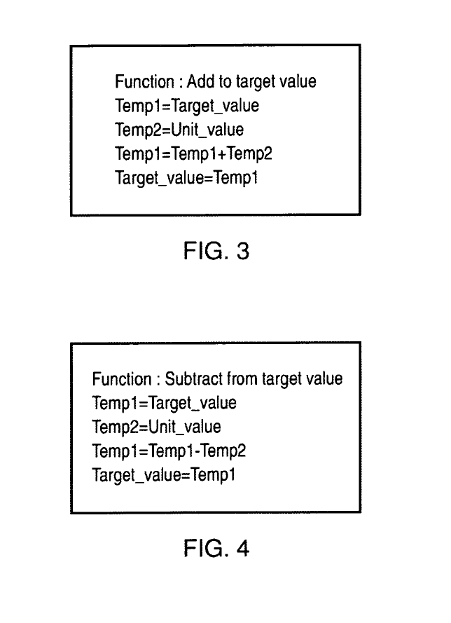

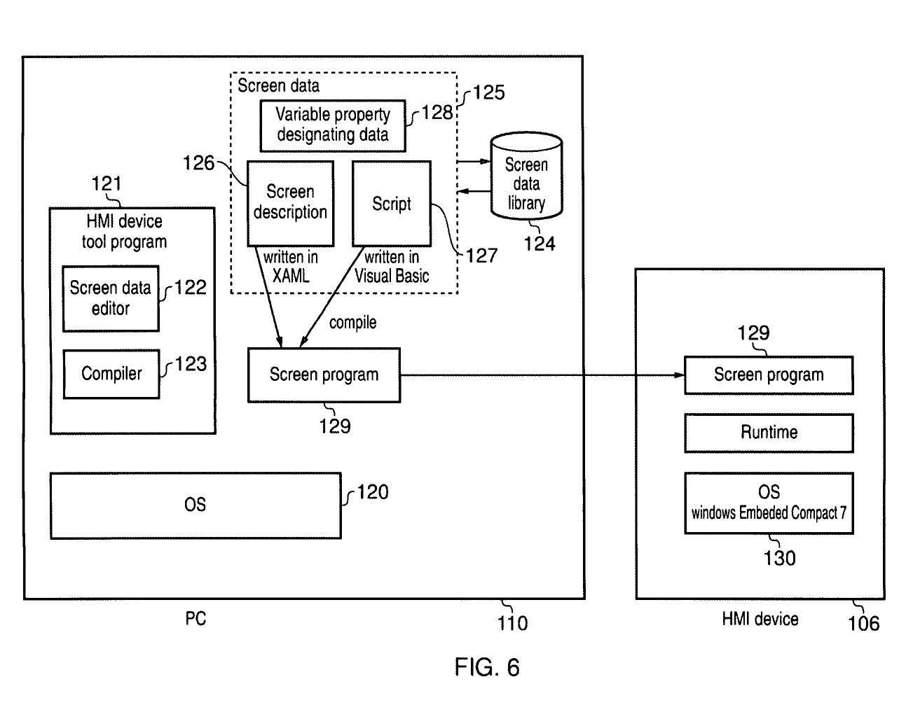

Various variables associated with the object 10 are listed, each with a select button 20. A name, referred to herein as a “representative name” but also referred to as a nickname or argument name, may be associated with a variable name. The variables shown in FIG. 2(a) are all variables included in scripting programs associated with the object 10 and detected by a HMI tool program discussed later with reference to FIG. 6. Thus, in FIG. 2(a), line 21 represents the quantity represented by the value displayed in the display part 11, lines 22 to 25 represent the quantities “1”, “5”, “10”, and “100” represented by the radio buttons 14, and lines 26 to 28 represent internal quantities used in operating the object 10. The way that the quantities of lines 26 to 28 are used are those illustrated in FIGS. 3 and 4, for the addition and subtraction functions carried out by operation of the addition button 12 and the subtraction button 13 respectively. In FIGS. 3 and 4, the quantities “Temp1” and “Temp2” are e.g. the values stored in registers when the value shown in display part 11 is changed. The scripting program shown in FIG. 3 is assigned to Pressed Event of the ADD button. When the ADD button is pressed, this scripting program will be executed. Similarly, the scripting program shown in FIG. 4 is assigned to Pressed Event of the SUB button.

Each radio button has its scripting program (which is not shown in the drawings) to set a value of “Unit_value” in FIGS. 3 and 4. For example, when the radio button of “5” is pressed, the value of “Unit_value” is set to 5 which is the constant value of “Radio_value2”.

Thus, by operating the select buttons 20, the programmer who creates the object may select which properties of that object may be re-assigned. For example, if he selects the button 20 on line 21 only, a subsequent programmer will be able to re-assign the object 10 to a different quantity, but will not be able to change any of the other quantities, such as the quantities represented by the radio buttons 14. Similarly, if the creator selects the buttons for lines 22 to 25, but not any of the other buttons, a subsequent programmer will be able to change the values represented by the radio buttons 14, but not otherwise change the object, including being unable to change the quantity represented by the value shown in display part 11. The creator of the object 10 thus selects in advance which properties of the object 10 may have the corresponding quantity changed (i.e. the property be re-assigned).

Thus this embodiment proposes that, when an object is stored, an association record is also stored which indicates the property or properties of the object which are re-assignable and which are fixed. The creator programmer of the object determines the association record by selecting the re-assignable property or properties from candidate properties.

When a subsequent programmer retrieves the object 10 for re-use, the display shown in FIG. 2(a) may again be displayed as a template of the re-usable properties, with the properties which may be re-assigned highlighted in some way, or is it possible that only the properties that can be re-assigned (i.e. those which have been selected by use of the buttons 20) are displayed. Note that, at this time, the subsequent programmer cannot change the buttons 20, and so cannot alter which property or properties are re-assignable and which are not. The buttons 20 may not be displayed. Among the re-assignable variable names, only “Target_value” in this example, is rewritable. A subsequent programmer can re-assign a new variable by the deleting original variable name and inputting the name of the new variable.

When a subsequent programmer re-uses the object 10, the display shown in FIG. 2(b) may be displayed. The display includes only the re-assignable properties with their representative names. A subsequent programmer can re-assign the new variable by inputting a new variable name.

The programmer re-using the object thus is presented clearly with information that enables them to tell which properties of the object 10 can be re-assigned, and which cannot. This system enables the programmer re-using the object 10 to have a lower programming skill than the programmer who creates the object 10, but still be able to re-use the object by re-assigning the properties of the object which the creator has determined are available to be changed. The creator restricts the properties which can be changed, thereby limiting the ways that the object 10 may be re-used.

In the arrangements described above, the programmer who creates the object selects which properties of the object have variable quantities that may be re-assignable using template illustrated in the display of FIG. 2(a). However, other arrangements are possible which enable the programmer who creates the object to determine which property of properties of the object have variable quantities which may be re-assigned when the object is re-used. For example, at least with some programming languages which may be used for this invention, it is possible to set variable quantities as global variables, with other variable quantities not being global variables. In such an arrangement, the subsequent programmer may be able to re-assign the variable properties defined as a global variable, but will not be able to re-assign a variable property defined by a variable which is not a global one. In such an arrangement, the HMI tool program 121 shown in FIG. 6 can determine re-assignable variables without requiring a display such as the one shown in FIG. 2(a). Other arrangements for determining which properties can have their variable quantity re-assigned are also possible.

In practice, the display of a HMI device may show many objects, which are generally stored in the library. Indeed, it is usual for one or more objects to be assembled into a screen structure, and multiple screen structures stored in a library. That library may be stored in a memory of the HMI device itself, but it is more usual for the library to be stored in a separate computer device, such as a PC, and for only the screen structures which the HMI device needs for its current operation be copied from the library to the memory for display by the display of the HMI device.

Thus, a subsequent programmer may retrieve one of the screen structures from the library, and re-use one or more of the objects in that screen structure for a different purpose, by re-assigning the property of the object to a different parameter effectively, a new object, and hence a new screen structure, is created and then transferred to the HMI device and also optionally stored in the library. Of course, it is also possible that when an object is re-used, the new object thus created is stored separately in the library.

A subsequent programmer may re-use an object independently of a screen structure or may extract an object from a screen structure for re-use, and may combine a plurality of re-used objects into a new screen structure.

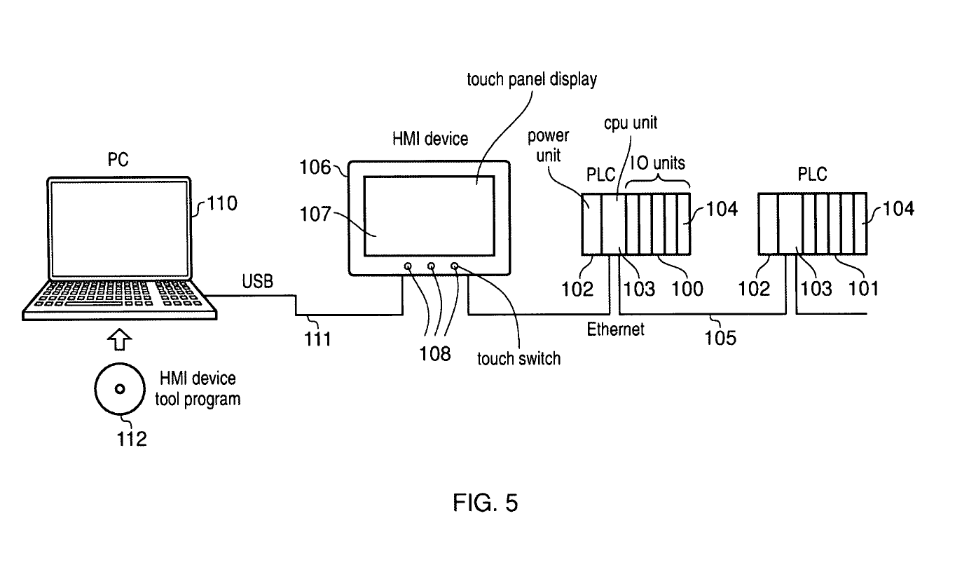

An example of a programmable system involving a HMI device is shown in FIG. 5. The system comprises a plurality of programmable controllers 100, 101 each of which may involve components such as a power unit 102, a CPU unit 103, and other units 104. The programmable controllers 100, 101 are interconnected e.g. by an ethernet connection 105 which also connects the programmable controllers 101, 102 to a HMI display device 106. That display device 106 comprises a display panel 107 and e.g. touch switches 108. The display device 106 has a memory in which a library of screen structures are stored. When a suitable screen structure is displayed, on the panel display 107, the user may use panel 107, or the switches 108, to trigger the display device 106 to change the operation of one or more of the programmable controllers 100, 101, and hence the other components (not shown) of the system controlled by the programmable controllers 100, 101.

Different users may require different screen structures, to permit them to carry out different functions on the system (e.g. operation, repair, or administration) and each of the screen structures may involve one or more objects.

Programming of a library of screen structure for use in the HMI display device 106 is carried out in a separate computer, such as a PC 110, that may be connected to the HMI display device 106. Initially, an experienced programmer may create multiple objects for the HMI device display 106, and assemble those objects into the appropriate screen structures that will be needed. Those screen structures may be stored in a library of screen structures, one or more of which screen structures is then transferred from the PC 110 to the HMI display device 106, e.g. via connection 111. The PC 110 will normally be pre-programmed with an appropriate tool program, from e.g. a disc 112.

Suppose now that a subsequent programmer wants to re-assign one or more objects of one or more of the screen structures stored in the HMI display device 106. In such circumstances, the library of screen structures retrieved at the PC. One or more of the objects may then be re-used, as described previously, to create a new screen structure containing that new object. The screen structure is then added to the library, and transferred back to the HMI display device 106 for subsequent use by re-connecting the PC to the HMI device.

It should be noted that, in the creation of a new screen structure, an existing screen structure in the library may be retrieved and one or more objects of that screen structure re-used, with other elements (includes other objects) of that screen structure unchanged. The existing screen structure is thus itself retrieved. Even if only a small unit of an existing screen structure is re-used, a new screen structure is created.

FIG. 6 then illustrates in more detail the program components within the PC 110 and the HMI display device 106 in the embodiment of FIG. 5. As shown in FIG. 6 the PC 110 has an operating system 120, an HMI device tool program 121, normally consisting of a screen data editor 122 and a complier 123, which may be loaded on the PC 110 from the disk 112. It will also have a screen data library 124 which contains programming structures which may be used to create objects such as object 10. The data library, under control of the HMI device tool program, creates screen data 125 such as screen descriptions which may be written in XAML, script text written in e.g. visual basic, and variable property data 128. These may be compiled to form a screen program 129 containing one or more screen structures in a library. One or more of those screen structures may then be transferred to the HMI display device 106, where it may be operated by the operating system 130 of the HMI device 106. In practice, with such a system, it will be normal for the programmer to create the library of screen structures, and/or objects for use in such screen structures, prior to the step of compiling the screen program 129.

In practice, the screen structures stored in the library may be stored as source lists which are compiled into screen structures for display on the HMI device 106 when the screen structure is transferred to the HMI device 106.

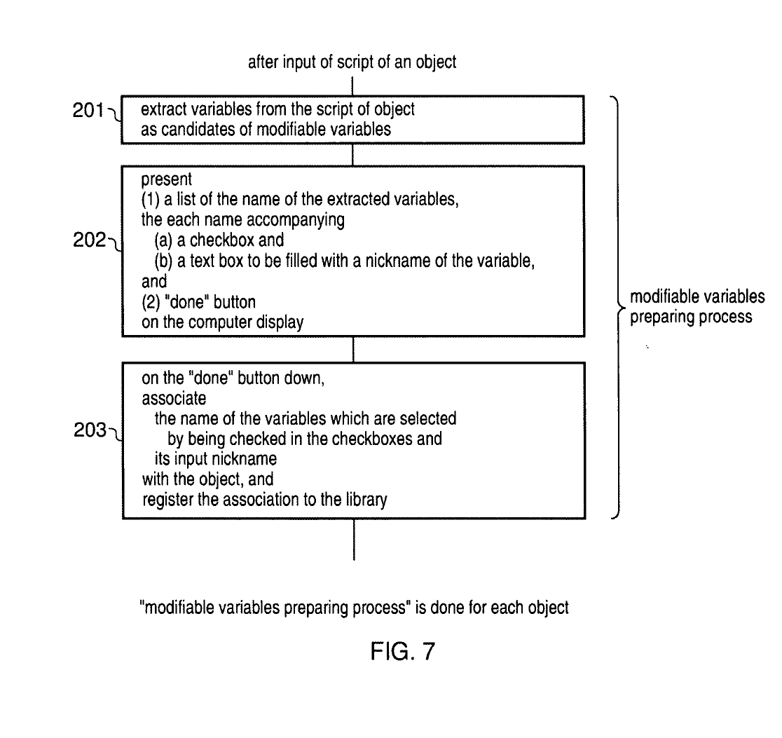

FIG. 7 illustrates one possibility for enabling a programmer creating an object, for storage in a library of such objects and/or screen structures, to determine which properties of the object may subsequently be varied. Initially, the script of an object is received. Then, at step 201, variables of the script of the object are extracted as modifiable variables. At this stage, all possible modifiable variables (candidate variables) may be indicated, such as shown by the table of FIG. 2(a). Then, at step 202, a list of the names of the extracted variables as is displayed, together with the check boxes shown by buttons 20 in FIG. 2(a), a text box to be filled with the nickname, (argument name, representative name), of the variable (the right-most column into FIG. 2(a)) and a “done” button.

The creator programmer then selects amongst the boxes 20 in FIG. 2(a) to indicate which properties of the objects may subsequently be varied, and presses the “done” button. When that happens, at step 203 in FIG. 7, the name of the variable which has been selected and its nickname are associated with the object, and that association is registered as an association record in the library in which the object is stored. This process is continued for each object wanted.

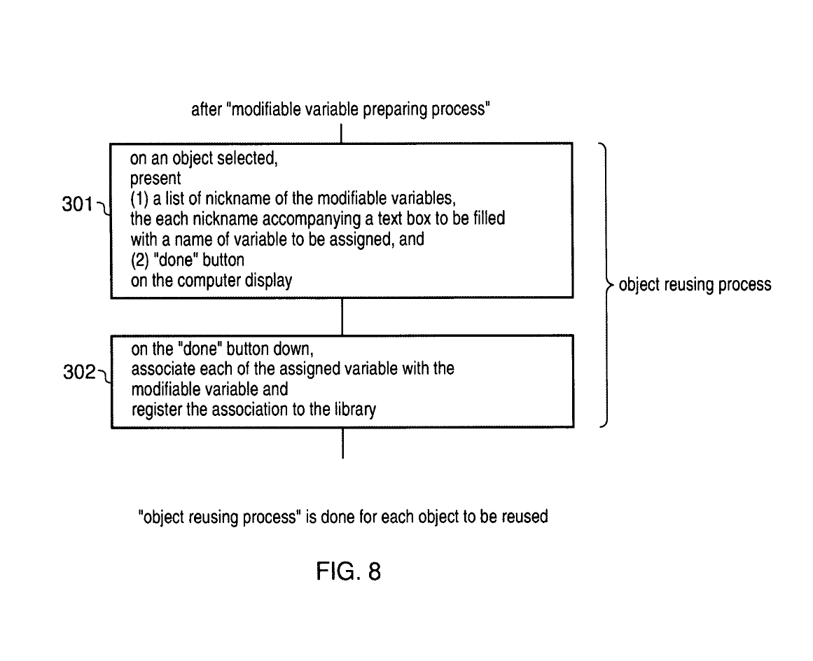

Similarly, FIG. 8 illustrates the re-use of an object. When an object is selected to be re-used, a template associated with that object is displayed at step 301, but the programmer is now presented only with a list of the nicknames of the modifiable variables, and the variable to be assigned. There is also a “done” button. The subsequent programmer then may re-assign the variable, to re-used the object and create a new object. The programmer then presses the “done button”, and the new object, together with its assigned variables, etc, are stored in the library in step 302.

Thus, with the present invention, a first programmer may create complex objects and pre-determine which properties of those objects may be re-assigned. Other properties are then fixed. When a subsequent programmer, who may be less experienced, then wants to re-use the object, that programmer is presented with information from a template created from an association record set at the time when the object was created, and stored in a way linked to the object, to display to that subsequent programmer which properties of the object may be re-assigned. When those properties are re-assigned, a new object is created and may be stored in e.g. the library of objects from which the object originally came. As mentioned, objects may be stored or grouped together in screen structures.

Furthermore, when an object is created, the programmer creating the object is presented with a list of candidate properties of the object which are available for re-assignment to allow the creator programmer easily to select the property or properties which a subsequent programmer is allowed to re-assign. This simplifies the selection process for the creator programmer.

1. A method of changing an object for use in a display screen of a human-machine interface device of a programmable system, comprising the steps of:
creating said object, said object comprising an assembly of properties of said object, at least some of said properties being properties associated with a corresponding variable quantity;
determining for said properties of said object associated with a corresponding variable quantity a property or properties for which the corresponding variable quantity is reassignable, with other property or properties of the object associated with a corresponding variable quantity being fixed;
storing said object in a library;
retrieving said object from said library;
displaying said property or properties of said object for which the corresponding variable quantity is reassignable;
reassigning a different variable quantity to a property of said property or properties for which the corresponding variable quantity is reassignable, thereby to change said object and thus create a new object; and
transferring said new object to a memory of said human-machine interface device, for display on said display screen;
wherein
said determining step includes carrying out a setting operation to determine said property or properties for which the corresponding variable quantity is reassignable and creating an association record identifying said property or properties for which the corresponding variable quantity is reassignable;
said storing step includes storing said association record in said library; and
said retrieving step includes retrieving said association record;
wherein said association record is used in said displaying step to identify for display said property or properties for which the corresponding variable quantity is reassignable.

2. A method according to claim 1, wherein setting said property or properties for which the corresponding variable quantity is reassignable based on a setting operation in said determining step includes presenting a list of candidate ones of said properties of said object for which the corresponding variable quantity is settable to be reassignable, and setting among said candidate ones of properties, said property or properties for which the corresponding variable quantity is reassignable.

3. A method according to claim 2, wherein said list of candidate ones of said properties of said object for which the corresponding variable quantity is set table to be reassignable is displayed together with check boxes associated with said candidate ones of said properties, the checking of one of said check boxes identifying the corresponding one of said candidate ones of said properties which are reassignable, thereby to set said property or properties for which the corresponding variable quantity is reassignable.

4. A method according to claim 1, wherein the setting operation to determine the property or properties for which the corresponding variable quantity is reassignable comprises setting said variable quantity as a global variable.

5. A method according to claim 1, wherein, in said displaying step, a template is displayed, said template listing at least the property or properties for which the corresponding variable quantity is reassignable, said template being derived from said association record.

6. A method according to claim 5, wherein said determining step includes setting a representative name associated with said candidate one of said properties of said object, said template also lists a representative name for each variable quantity which is reassignable.

7. A method according to claim 1, wherein said new object is transferred to said memory as part of a screen structure for said display screen.

8. A method according to claim 7, wherein an initial screen structure is stored in said library when said object is stored in said library, said initial screen structure containing said object is retrieved from said library when said at least one object is retrieved from said library, and prior to said transferring step, said new object replaces said object in said initial screen structure, thereby to form said screen structure which is transferred.

9. A method according to claim 8, wherein prior to said transferring step, said screen structure containing said new object is stored in said library.

10. A method according to claim 1, wherein said object comprises one of a plurality of objects, each object comprising an assembly of properties of the corresponding object, and said plurality of objects are parts of a screen structure for said display screen of said human-machine interface device.

11. A programmable computer device for changing an object for use in a display screen of a human-machine interface device of a programmable system, the computer device having a processor and a memory, the processor being arranged to:
create said object, said object comprising an assembly of properties of said object, at least some of said properties being properties associated with a corresponding variable quantity;
determine for said properties of said object associated with a corresponding variable quantity a property or properties for which the corresponding variable quantity is reassignable, with other property or properties of the object associated with a corresponding variable quantity being fixed, by carrying out a setting operation to determine said property or properties for which the corresponding variable quantity is reassignable and creating an association record identifying said property or properties for which the corresponding variable quantity is reassignable;
store said object and said association record in a library in said memory of said computer device;
retrieve said object and said association record from said library;
display said property or properties of said object for which the corresponding variable quantity is reassignable;
reassign a different variable quantity to a property of said property or properties for which the corresponding variable quantity is reassignable, thereby to change said object and thus create a new object; and
transfer said new object to a memory of said human-machine interface device, for display on said display screen;
wherein said association record is used by said processor to identify for display said property or properties for which the corresponding variable quantity is reassignable.

12. A programmable system comprising a computer device according to claim 11 and a human-machine interface having a display screen and a memory, the human-machine interface being arranged to receive said new object from the computer device, store said new object in the memory of the human-machine interface, and display said new object on the display screen of the human-machine interface.

13. A computer program which, when run on a programmable computer device for changing an object for use in a display screen of a human-machine interface of a programmable system, causes the computer device to carry out the steps of:
creating said object, said object comprising an assembly of properties of said object, at least some of said properties being properties associated with a corresponding variable quantity;
determining for said properties of said object associated with a corresponding variable quantity a property or properties for which the corresponding variable quantity is reassignable, with other property or properties of the object associated with a corresponding variable quantity being fixed;
storing said object in a library;
retrieving said object from said library;
displaying said property or properties of said object for which the corresponding variable quantity is reassignable;
reassigning a different variable quantity to a property of said property or properties for which the corresponding variable quantity is reassignable, thereby to change said object and thus create a new object; and
transferring said new object to a memory of said human-machine interface device, for display on said display screen;
wherein
said determining step includes carrying out a setting operation to determine said property or properties for which the corresponding variable quantity is reassignable and creating an association record identifying said property or properties for which the corresponding variable quantity is reassignable;
said storing step includes storing said association record in said library; and
said retrieving step includes retrieving said association record;
wherein said association record is used In said displaying step to identify for display said property or properties for which the corresponding variable quantity is reassignable.

14. A recording medium on which the program of claim 13 is recorded.
